(19) United States
(12) Patent Application Publication
(10) Pub. No.: US 2026/0011169 A1
(43) Pub. Date: Jan. 8, 2026

(54) DOCUMENT RECOGNITION APPARATUS, DOCUMENT RECOGNITION METHOD, AND COMPUTER-READABLE, AND NON-TRANSITORY MEDIUM

(71) Applicant: PFU Limited, ISHIKAWA (JP)

(72) Inventors: Masayoshi HAYASHI, ISHIKAWA (JP); Kiyoto KOSAKA, ISHIKAWA (JP)

(21) Appl. No.: 19/240,353

(22) Filed: Jun. 17, 2025

(30) Foreign Application Priority Data
Jul. 8, 2024 (JP) 2024-109719

(51) Int. Cl. G06V 30/414; G06V 10/74; G06V 10/762; G06V 10/764; G06V 10/82; G06V 30/19; G06V 30/196; G06V 30/413

(52) U.S. Cl. CPC G06V 30/414; G06V 10/761; G06V 10/762; G06V 10/764; G06V 30/19093; G06V 30/19107; G06V 30/196; G06V 30/413; G06V 10/82

(57) ABSTRACT

A document recognition apparatus includes circuitry that extracts text information from document data, identifies an item character string and a structure of the document data from the extracted text information, the item character string being a character string for identifying a document type of the document data, and determines the document type of the document data, based on a combination of the item character string and the structure of the document data.

### CROSS-REFERENCE TO RELATED APPLICATIONS

This patent application is based on and claims priority pursuant to 35 U.S.C. § 119 (a) to Japanese Patent Application No. 2024-109719, filed on Jul. 8, 2024, in the Japan Patent Office, the entire disclosure of which is hereby incorporated by reference herein.

### BACKGROUND

The present disclosure relates to a document recognition apparatus, a document recognition method, and a computer-readable, non-transitory medium.

Techniques for extracting text information from a document using optical character recognition (OCR) technology include techniques for determining a document type and extracting text information according to the document type. Thus, various methods for determining the document type are devised. A technique for inputting a character string extracted from a document to a model trained by machine learning to perform clustering is disclosed.

The technique of the related art, however, may cause an error in determining various types of documents. The various types of documents include, for example, the contract, the invoice, the delivery note, the order form, the quotation, the receipt, and the driver's license. Documents with similar contents (such as the invoice, the delivery note, the order form, the quotation, and the receipt) are difficult to distinguish from one another even with artificial intelligence (AI).

### SUMMARY

The document recognition apparatus according to one aspect of the present disclosure includes circuitry. The circuitry extracts text information from document data. The circuitry identifies an item character string and a structure of the document data from the extracted text information. The item character string is a character string for identifying a document type of the document data. The circuitry determines the document type of the document data, based on a combination of the item character string and the structure of the document data.

The document recognition method performed by one or more computers according to another aspect of the present disclosure includes extracting text information from document data; identifying an item character string and a structure of the document data from the extracted text information, the item character string being a character string for identifying a document type of the document data; and determining the document type of the document data, based on a combination of the item character string and the structure of the document data.

The computer-readable, non-transitory medium according to still another aspect of the present disclosure stores a computer program, the computer program causing one or more computers to perform a process including extracting text information from document data; identifying an item character string and a structure of the document data from the extracted text information, the item character string being a character string for identifying a document type of the document data; and determining the document type of the document data, based on a combination of the item character string and the structure of the document data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of a document recognition system according to one embodiment;

FIG. 2 is a diagram illustrating an example of a hardware configuration of a document recognition apparatus;

FIG. 3 is a diagram illustrating an example of a functional configuration of the document recognition apparatus;

FIG. 4 is a flowchart of an example of a document type determination process performed by the document recognition apparatus;

FIGS. 5A to 5C are diagrams for describing an example of a fixed format document determination method performed by the document recognition apparatus;

FIGS. 6A to 6D are diagrams for describing an example of a term frequency-inverse document frequency (TF-IDF) calculation method performed by the document recognition apparatus;

FIG. 7 is a diagram illustrating an example of a template for appearance frequencies of designated terms in each document type, created by the document recognition apparatus;

FIGS. 8A and 8B are diagrams each illustrating an example of a template for ratios for parts of speech in each document type, created by the document recognition apparatus;

FIG. 9 is a flowchart of an example of a second designated document identification process performed by the document recognition apparatus;

FIG. 10 is a diagram illustrating an example of document data handled in the document recognition apparatus;

FIG. 11 is a diagram illustrating an example of structure information handled in the document recognition apparatus;

FIGS. 12A and 12B are diagrams illustrating an example of the structure information handled in the document recognition apparatus;

FIG. 13 is a block diagram of an example of functions of a training unit that generates a classifier in the document recognition apparatus; and

FIG. 14 (FIGS. 14A, 14B, 14C) is a flowchart of a modification of the document type determination process performed by the document recognition apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described below with reference to the drawings. In the drawings, the same components are denoted by the same reference signs, and duplicated description may be omitted.

### Example of System Configuration

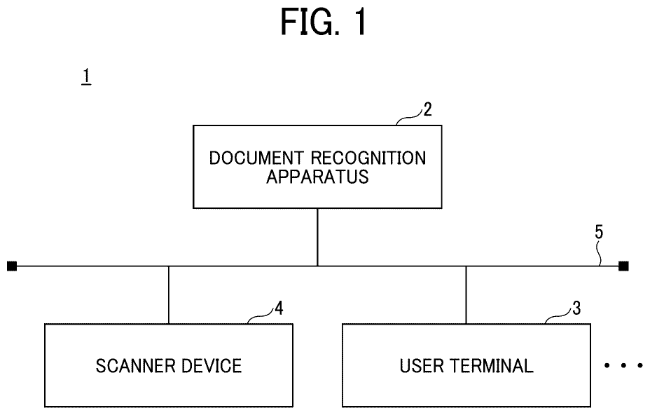

FIG. 1 is a diagram illustrating a general arrangement of a document recognition system 1 according to one embodiment. As illustrated in FIG. 1, the document recognition system 1 includes a document recognition apparatus 2, a user terminal 3, and a scanner device 4, which communicate with one another via a network 5.

The network 5 may be, for example, an in-house local area network (LAN). The network 5 may be implemented by wireless communication such as Wi-Fi® (® is omitted below). When the document recognition apparatus 2 is in the cloud, the network 5 may include a wide area network (WAN) or Internet. For example, the user terminal 3 can transmit, to the document recognition apparatus 2, image data obtained by the scanner device 4 through reading.

Note that the document recognition apparatus 2 may be directly connected to the scanner device 4 by a cable such as a Universal Serial Bus (USB) cable in a one-to-one manner. In the case of one-to-one connection, the document recognition apparatus 2 and the scanner device 4 may wirelessly communicate with each other. Examples of such a communication method include Wi-Fi direct and Bluetooth®.

The document recognition apparatus 2 and the user terminal 3 may each be any information processing apparatus having a communication function, e.g., a personal computer (PC), a server apparatus, a smartphone, or a tablet PC.

For example, the document recognition apparatus 2 may perform character recognition using the OCR technology on document data, which is image data of a document read by the scanner device 4, to extract text information. The document recognition apparatus 2 may allow a user to check or correct the result. The document recognition apparatus 2 may extract the text information from document data transmitted from the user terminal 3.

The scanner device 4 is an optical reading device. The scanner device 4 reads an original to generate document data, which is image data, and transmits the document data to the document recognition apparatus 2. In the present embodiment, the scanner device 4 scans a document. FIG. 1 illustrates the scanner device 4. However, image data subjected to character recognition may be obtained by a digital camera or the like through imaging. The image data obtained by the digital camera through imaging may be transmitted via the network 5, or stored in a removable storage medium. When the user attaches the storage medium to the document recognition apparatus 2, the document recognition apparatus 2 can acquire the image data (i.e., document data).

The scanner device 4 may be a device called a multifunction peripheral (MFP). That is, the scanner device 4 may have a printer function, a copy function, and a facsimile function in addition to a scanner function.

In FIG. 1, the document recognition apparatus 2 and the scanner device 4 are separate apparatuses. However, the document recognition apparatus 2 and the scanner device 4 may be integrated into a single apparatus (e.g., MFP).

### Example of Hardware Configuration

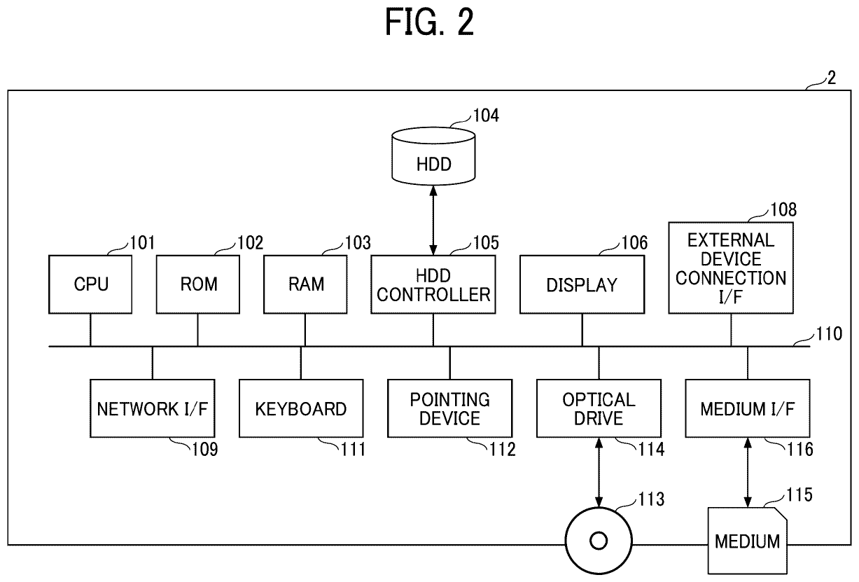

An example of a hardware configuration of the document recognition apparatus 2 will be described with reference to FIG. 2. FIG. 2 is a diagram illustrating an example of the hardware configuration of the document recognition apparatus 2 according to one embodiment.

As illustrated in FIG. 2, the document recognition apparatus 2 includes a central processing unit (CPU) 101, a read-only memory (ROM) 102, a random access memory (RAM) 103, a hard disk drive (HDD) 104, an HDD controller 105, a display 106, an external device connection interface (I/F) 108, a network I/F 109, a bus line 110, a keyboard 111, a pointing device 112, an optical drive 114 for a digital versatile disc-rewritable (DVD-RW) or the like, and a medium I/F 116.

Among these components, the CPU 101 controls the overall operation of the document recognition apparatus 2. The ROM 102 stores a program such as an Initial Program Loader (IPL) used for executing the CPU 101. The RAM 103 is used as a work area for the CPU 101. The HDD 104 stores various types of data such as a program.

The HDD controller 105 controls reading or writing of various types of data from or to the HDD 104 under the control of the CPU 101. The display 106 displays various types of information such as a cursor, a menu, a window, text, or an image. The external device connection I/F 108 is an interface for connecting various external devices to the document recognition apparatus 2. Examples of the external devices include a USB memory and a printer.

The network I/F 109 is an interface for communicating data via the network 5. The bus line 110 includes an address bus and a data bus for electrically connecting the components such as the CPU 101 to one another.

The keyboard 111 is an example of an input device including a plurality of keys to be used for inputting characters, numerical values, various instructions, and the like. The pointing device 112 is an example of an input device for selecting or executing various instructions, selecting a target of processing, moving a cursor, and the like.

The optical drive 114 controls reading or writing of various types of data from or to a DVD-RW 113 which is an example of a removable recording medium. The optical drive 114 is not limited to a drive for a DVD-RW and may be, for example, a drive for a digital versatile disc recordable (DVD-R). The medium I/F 116 controls reading or writing (storing) of data from or to a recording medium 115 such as a flash memory.

### Example of Functional Configuration

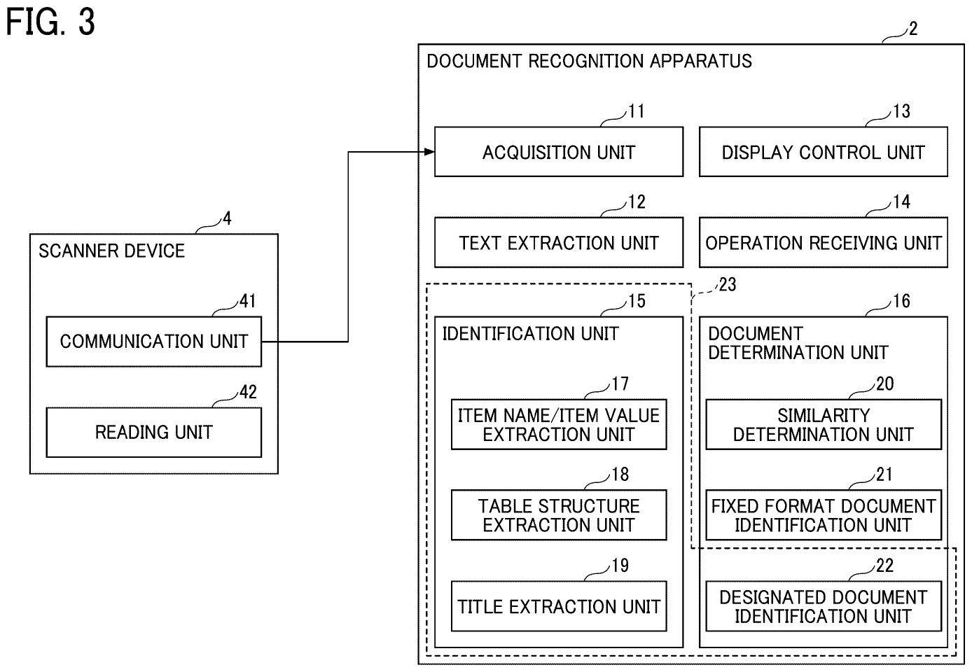

An example of a functional configuration of the document recognition apparatus 2 will be described next with reference to FIG. 3. FIG. 3 is a diagram illustrating an example of the functional configuration of the document recognition apparatus 2 according to one embodiment.

### Scanner Device

The scanner device 4 includes a communication unit 41 and a reading unit 42. The reading unit 42, which may include a line sensor and a feeder, feeds documents such as forms one by one. The reading unit 42 scans a surface of an original with the line sensor to generate image data having a certain resolution and a certain gradation. Instead of the scanner device 4, a device having a camera function, such as a digital camera, may acquire image data of a document.

The communication unit 41, which may be implemented by a network interface circuit, communicates with the document recognition apparatus 2 according to a communication protocol such as Simple Network Management Protocol (SNMP) or communicates with the document recognition apparatus 2 via a dedicated line such as a USB cable. The communication unit 41 transmits the image data generated by the reading unit 42 to the document recognition apparatus 2.

### Document Recognition Apparatus

The document recognition apparatus 2 includes an acquisition unit 11, a text extraction unit 12, a display control unit 13, an operation receiving unit 14, an identification unit 15, and a document determination unit 16. The identification unit 15 includes an item name/item value extraction unit 17, a table structure extraction unit 18, and a title extraction unit 19. The document determination unit 16 includes a similarity determination unit 20, a fixed format document identification unit 21, and a designated document identification unit 22. Note that the identification unit 15 and the designated document identification unit 22 are also collectively referred to as a “classifier 23” below.

These units of the document recognition apparatus 2 are functions or units that are implemented by the CPU 101 of the document recognition apparatus 2 executing commands according to a program. The program may be, for example, a native application dedicated to the document recognition apparatus 2, or a general-purpose native application. The program may be a web app as described later.

The acquisition unit 11 acquires document data generated by the scanner device 4 via the network 5, for example. The acquisition unit 11 communicates with the scanner device 4 according to a communication protocol such as SNMP. The acquisition unit 11 may also acquire document data generated by a device having a camera function such as a digital camera, may acquire document data from the user terminal 3, or may read document data from a storage medium.

The text extraction unit 12 extracts text information from the document data. The text information may be extracted by performing character recognition processing in the case of the document data obtained using the scanner device 4 and by reading text included in the document data in the case of the document data acquired from the user terminal 3. The document data may be image data of a document generated by the scanner device 4 or document data acquired from the user terminal 3. The text extraction unit 12 can extract a collection of character strings as the text information, and extract coordinates for identifying a position such as a circumscribed rectangle of each character string.

The display control unit 13 causes displays of the document recognition apparatus 2 and the user terminal 3 to display various screens. The display control unit 13 causes the displays to display document data and text information extracted by the text extraction unit 12, for example. The display control unit 13 may cause the displays to display a document recognition result (such as a determination result of the contract, the invoice, the delivery note, the order form, the quotation, the receipt, and the driver's license).

The operation receiving unit 14 receives various operations on the document recognition apparatus 2. For example, the operation receiving unit 14 receives an operation to start a document type determination process.

The identification unit 15 identifies, from the extracted text information, an item character string and a structure of the document data. The item character string is a character string for identifying the document type. The structure of the document data may be identified based on a positional relationship between a ruled line and a character string included in the document data. The structure of the document data may be identified based on an arrangement of a character string and the item character string included in the document data. That is, the identification unit 15 successfully identifies the structure of the document data also when the document data includes no ruled lines.

The document determination unit 16 determines the document type of the document data, based on a combination of the item character string and the structure of the document data. The combination of the item character string and the structure of the document data includes a concept of a positional relationship between a ruled line and a character string included in the document data. The positional relationship may be represented by coordinates in the document data.

The document determination unit 16 may use a trained model to determine the document type of the document data in a plurality of steps. The trained model has learned, using document types as training data, a feature quantity for each of the document types. The feature quantity is calculated based on the structure of the document data and the item character string. Note that the determination of the document type of the document data using the trained model may be performed in all steps or one or more steps among all steps.

The document determination unit 16 determines, as a fixed format document, a piece of document data corresponding to a predetermined format. The document determination unit 16 determines, as a first designated document, a piece of document data for which just a single document type is determined based on the combination of the structure of the document data and the item character string among pieces of document data that are not determined as the fixed format document. The document determination unit 16 determines, as a second designated document, a piece of document data for which a plurality of document types are determined among the pieces of document data that are not determined as the fixed format document.

For example, a contract including a single document type is the first designated document. For example, document data that includes the sales slip and the receipt and is treated as the “receipt” is determined as the second designated document because the document data includes the sales slip and the receipt.

The item name/item value extraction unit 17 extracts an item name and an item value from the document data. The extraction method will be described in detail later. The item name and the item value serve as inputs to a model generated by machine learning. An output from the model is the document type.

The table structure extraction unit 18 detects, for example, ruled lines to extract a table structure from the document data. The table structure refers to the entire table, ruled lines, an item name and an item value in the table, and position information of the item name and the item value. The table structure also serves as an input to the model.

The title extraction unit 19 extracts a title from the document data. The extraction method will be described in detail later. The title serves as an input to the model generated by machine learning. An output from the model is the document type.

The similarity determination unit 20 compares a template prepared in advance with information obtained by forming the text information and the table structure extracted from the document data to fit the template, and determines whether the document data is a designated document or a document of the other type.

The fixed format document identification unit 21 determines whether the document data is a fixed format document such as the driver's license. The fixed format document identification unit 21 compares the format of a fixed format document with the text information and the table structure extracted from the document data, and determines that the document data is the fixed format document when a match is higher than or equal to a certain level. The format is prepared in advance for each fixed format document.

The designated document identification unit 22 inputs the title, the item name, the item value, and the table structure to the model, and determines the document type based on the output of the model. Since the fixed format document, the document of the other type, and some of the designated documents have been already determined, the output document type indicates a document type other than these types. This can thus improve the determination accuracy of the model.

### Overall Process Flow

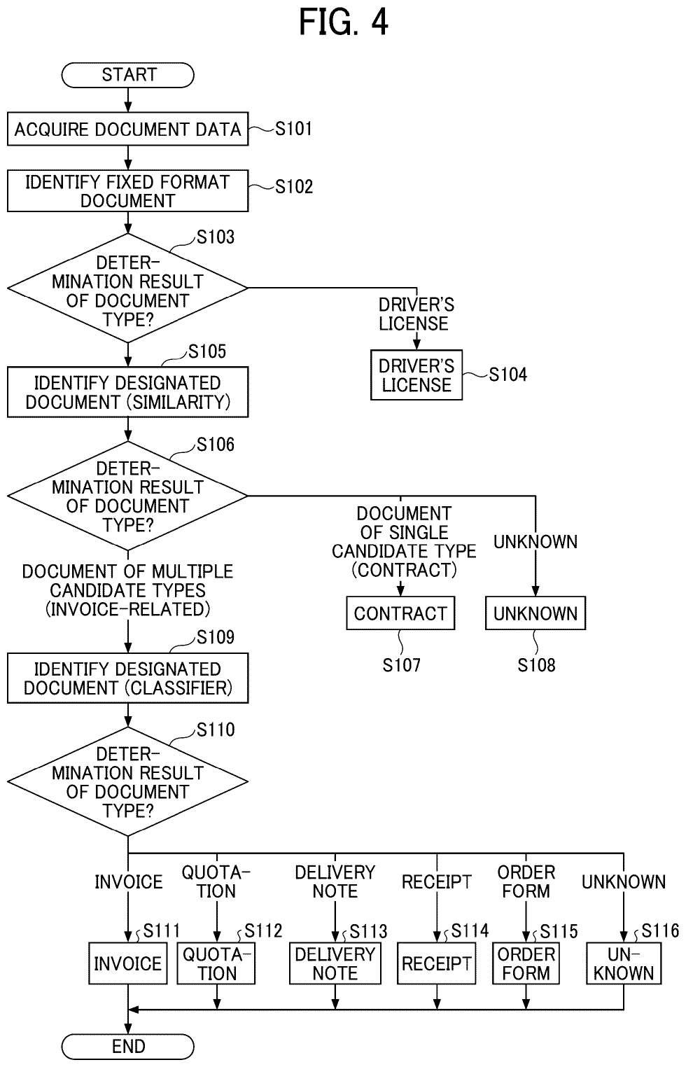

A flow of the document type determination process performed by the document recognition apparatus 2 will be described next. FIG. 4 is a flowchart of the document type determination process performed by the document recognition apparatus 2 according to one embodiment. As illustrated in FIG. 4, in this process, it is determined whether document data is the fixed format document, the first designated document, or the second designated document in one of steps. Each step will be described in detail below.

Note that in which step the determination is made for the document data depends on the document type. In FIG. 4, document types to be classified are as follows. Fixed format document: driver's license First designated document: contract Second designated document: invoice, quotation, delivery note, receipt, and order form

The scanner device 4 reads a document to generate document data, or the user terminal 3 holds the generated document data. The acquisition unit 11 acquires such document data in step S101. The text extraction unit 12 performs character recognition such as OCR on the document data.

The fixed format document identification unit 21 identifies a fixed format document in step S102, and determines whether the text information (such as character strings and coordinates) and the table structure extracted from the document data correspond to the driver's license which is the fixed format document in step S103.

When the fixed format document identification unit 21 determines that the document data is the driver's license which is the fixed format document (YES in step S103), the process proceeds to step S104. In step S104, the document determination unit 16 determines that the document data is the driver's license which is the fixed format document. When the determination in step S103 indicates No, the process proceeds to step S105.

In step S105, the similarity determination unit 20 calculates a similarity between a template prepared in advance for the first designated document and information obtained by converting the document data to have the same format as the template, and determines whether the similarity is higher than or equal to a threshold. When a plurality of templates are prepared, the information is compared with all the templates.

In step S106, the designated document identification unit 22 determines the document type, based on a calculation result of the similarity obtained in step S105. The document determination unit 16 determines, as the first designated document, a piece of document data for which just a single document type is determined among pieces of document data that are not determined as the fixed format document.

The document determination unit 16 determines the document data for which just the contract is determined, as the contract which is the first designated document, in step S107. When the document data is of an unknown type, the document determination unit 16 processes the document data such that the document type is unknown in step S108.

The document determination unit 16 determines, as the second designated document, a piece of document data for which a plurality of document types are determined, among the pieces of document data that are not determined as the fixed format document. The designated document identification unit 22 and the identification unit 15 identify the document type the document data corresponds to among the document types in step S109. In step S110, the designated document identification unit 22 determines the document type, based on an identification result obtained in step S109.

When the document type of the document data is identified as the invoice, the document determination unit 16 determines that the document type is the invoice in step S111. When the document type of the document data is identified as the quotation, the document determination unit 16 determines that the document type is the quotation in step S112. When the document type of the document data is identified as the delivery note, the document determination unit 16 determines that the document type is the delivery note in step S113.

When the document type of the document data is identified as the receipt, the document determination unit 16 determines that the document type is the receipt in step S114. When the document type of the document data is identified as the order form, the document determination unit 16 determines that the document type is the order form in step S115. When the document data is of an unknown type, the document determination unit 16 processes the document data such that the document type is unknown in step S116. Processing in each step will be described in detail below.

### S102: Identification of Fixed Format Document

The document determination unit 16 determines, as the fixed format document, document data corresponding to a predetermined format. The fixed format document indicates a document whose format is uniquely determined once the document type is determined. For example, application documents for in-house use and cards used in personal authentication (e.g., driver's license or identification card such the Individual Number card used as personal identification in Japan) are fixed format documents.

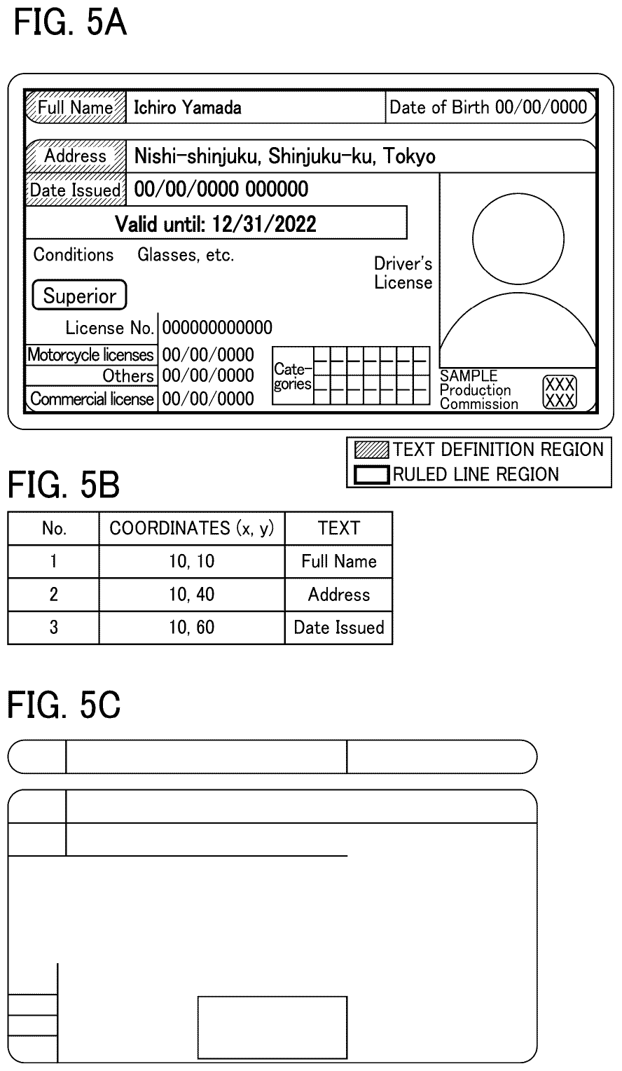

An overview of determination of a fixed format document will be described with reference to FIGS. 5A to 5C. FIGS. 5A to 5C are diagrams for describing an example of a fixed format document determination method performed by the document recognition apparatus 2 according to one embodiment.

FIG. 5A illustrates a driver's license which is an example of the fixed format document. The format of the fixed format document includes information obtained by extracting text, coordinates of the text, and an arrangement from the fixed format document. FIG. 5A illustrates text definition regions where “Full Name”, “Address”, and “Date Issued” are written, and some ruled lines.

FIG. 5B illustrates the text information and coordinates of each text definition region. FIG. 5C illustrates the ruled lines. The fixed format document identification unit 21 acquires, for example, the text information and the table structure, based on the coordinates determined by the format of the fixed format document among the text information and the table structure extracted from the document data. The fixed format document identification unit 21 determines whether the text information and the table structure match the text determined by the format of the fixed format document.

The fixed format document identification unit 21 detects straight lines having a certain length or longer from the document data by edge extraction or the like. The fixed format document identification unit 21 performs template matching on the straight lines and the ruled lines included in the format of the fixed format document, and determines whether the document data matches the format of the fixed format document depending on whether the match is higher than or equal to a certain level. The fixed format document identification unit 21 determines that the document data is the fixed format document associated with this format when both the match obtained for the text and the match obtained for the ruled lines are higher than or equal to a threshold.

### S105: Identification of Designated Document (Determination Based on Similarity)

The document recognition apparatus 2 extracts the text information from the document data in step S101. The similarity determination unit 20 extracts features from the text information and the table structure to compare the features with those of the template. The features are in the same format as the template. In the present embodiment, for example, the similarity determination unit 20 vectorizes the text information using a term frequency-inverse document frequency (TF-IDF). Definitions of TF and IDF are as follows.

TF: Appearance frequency of designated term in document =Number of times designated term appears in document/Number of times all terms appear in document

IDF: Inverse document frequency (rarity of designated term)=log (Number of documents (N)/Number of documents in which term t appears)

$$TF - IDF ( term frequencey - inverse document frequency ) = TF ⋆ IDF$$

Expression (1) is a computational expression of TF. Expression (2) is a computational expression of IDF. A large TF-IDF indicates that the term is meaningful.

$$T {F}_{d , t} = \frac{{n}_{d , t}}{{\sum }_{t = 1}^{T} {n}_{d , t}} \qquad ( 1 )$$

$$ID {F}_{t} = log \frac{N}{d {f}_{t}} \qquad ( 2 )$$

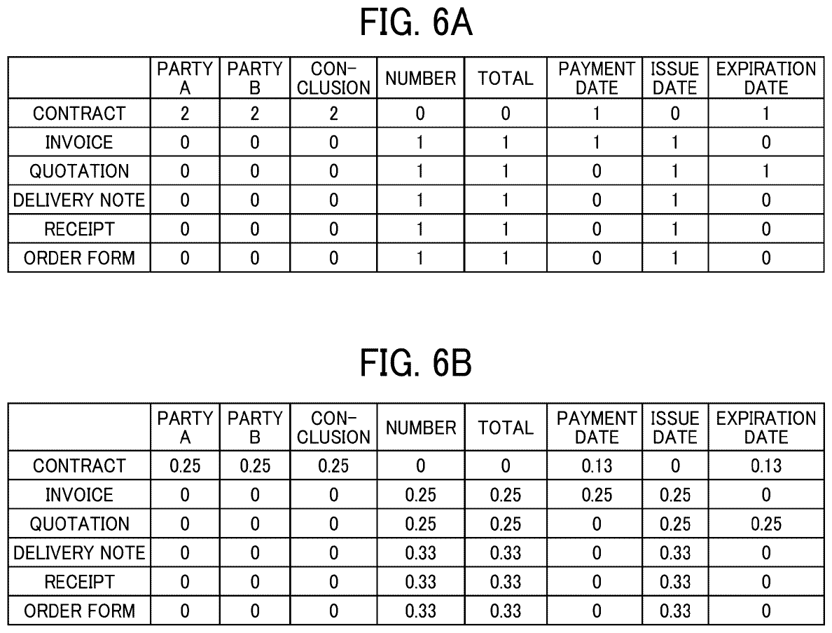

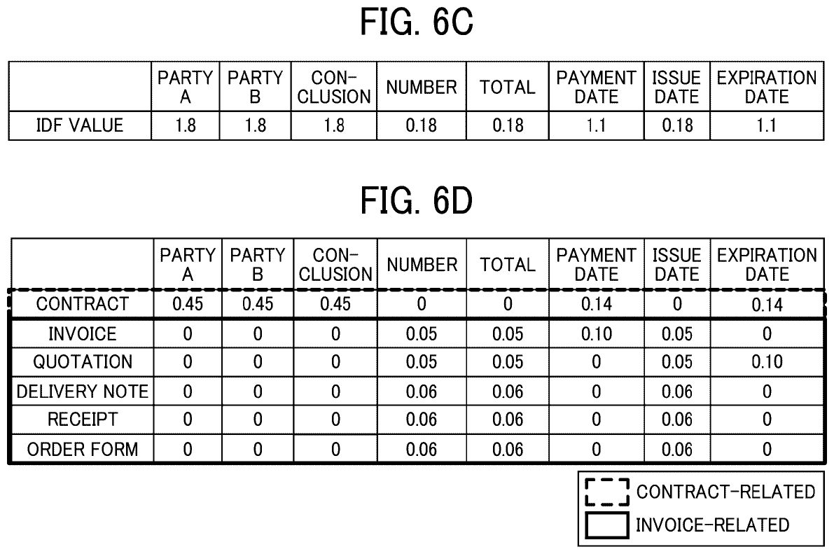

The TF-IDF calculation method will be described with reference to FIGS. 6A to 6D. FIGS. 6A to 6D are diagrams for describing an example of the TF-IDF calculation method performed by the document recognition apparatus 2 according to one embodiment.

FIG. 6A illustrates the number of times each designated term appears in each document. As illustrated in FIG. 6A, the total number of times each term appears is counted for each type of document. For example, in the case of the term “party A”, the term “party A” is searched for in the contract and is counted. Note that the number of documents of a single document type (e.g., contract) may be one or more. The number of documents is made equal across the document types or an average value or the like is used.

FIG. 6B illustrates the appearance frequency (TF) of each designated term in each document. As illustrated in FIG. 6B, the appearance frequency of each term in each document is calculated for each document type. For example, in the case of the term “party A” in the contract, the appearance frequency is 2/(2+2+2+1+1)=0.25.

FIG. 6C illustrates the rarity (IDF) of each term across the documents. As illustrated in FIG. 6C, the rarity of each term across the documents is calculated. IDF is based on the number of documents in which the term is found, and thus is calculated for each term. A larger IDF indicates a higher rarity.

FIG. 6D illustrates the importance (TF-IDF) of each designated term in each document. Specifically, TF-IDF is a product of TF illustrated in FIG. 6B and IDF illustrated in FIG. 6C.

The document recognition apparatus 2 sets TF-IDF created as illustrated in FIG. 6D in a template. In some cases, a template is created for each document. In other cases, a single template is created from a plurality of documents. The cases where a single template is created from a plurality of documents include a case where documents (e.g., the invoice and the quotation) have similar layouts, so that it is difficult to determine the document types thereof just by comparison with the respective templates. The documents having similar layouts are known, or are determined depending on whether TF-IDF is alike.

In FIG. 6D, there are a contract-related group and an invoice-related group for which templates for the invoice, the quotation, the delivery note, the receipt, and the order form are integrated into a single template. When the templates are integrated, each TF-IDF value may be an average of values for the same term. As described above, two templates, i.e., a contract-related group and an invoice-related group, are generated.

TF-IDF has the importance of each term used in the document, and thus serves as a feature vector representing the feature of the document. Therefore, the document type of the document data can be determined by comparison of TF-IDF created in advance for each document of a known document type with TF-IDF of the document data for the similarity.

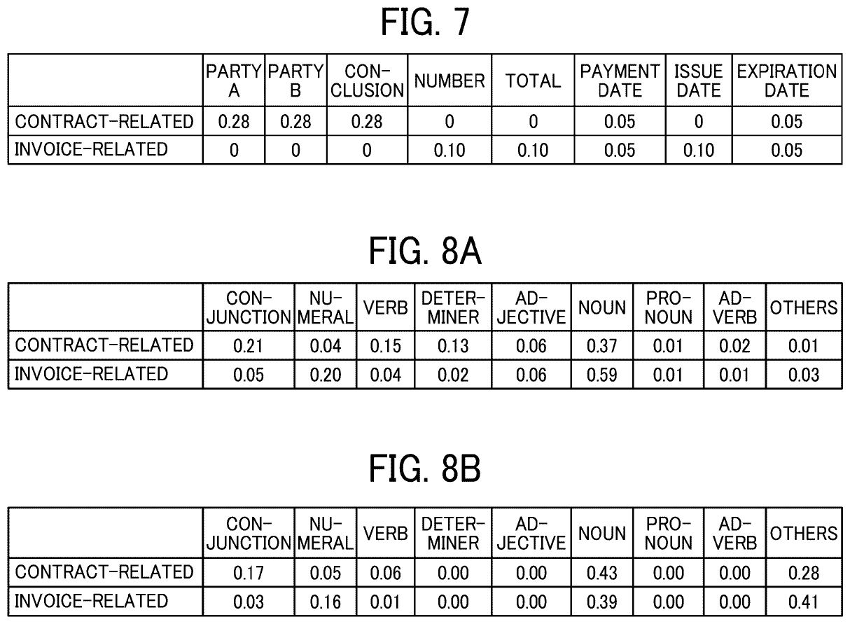

FIG. 7 is a diagram illustrating an example of a template for appearance frequencies of designated terms in each document type, created by the document recognition apparatus 2 according to one embodiment. FIG. 7 illustrates templates for contract-related documents and invoice-related documents. Specifically, the template for contract-related documents represents features of the contract. The template for invoice-related documents represents features of the invoice and the quotation.

FIGS. 8A and 8B are diagrams illustrating an example of a template for ratios for parts of speech in each document type, created by the document recognition apparatus 2 according to one embodiment. FIG. 8A illustrates templates for contract-related documents and invoice-related documents intended for the United States. FIG. 8B illustrates templates for contract-related documents and invoice-related documents intended for Japan. That is, the document recognition apparatus 2 can determine the document type, based on the features of the contract and the features of the invoice and quotation for each country.

The similarity determination unit 20 calculates TF-IDF of the document data, calculates a cosine similarity or the like between the calculated TF-IDF and TF-IDF of the template to determine whether the document data is similar to the template. Expression (3) represents a computational expression of the cosine similarity. cos (x, y) takes a value in a range from 1 to −1. A cosine similarity value closer to 1 indicates a higher similarity.

$$cos ( x , y ) = \frac{( x , y )}{\sqrt{{\vert x \vert}^{2}} ⋆ \sqrt{{\vert y \vert}^{2}}} \qquad ( 3 )$$

### S109: Identification of Designated Document (Determination by Classifier)

In the case of document data that is similar to the integrated template of a plurality of documents based on TF-IDF, the designated document identification unit 22 identifies which designated document the document data corresponds to among the types integrated.

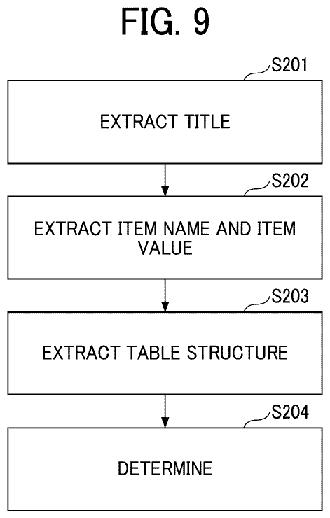

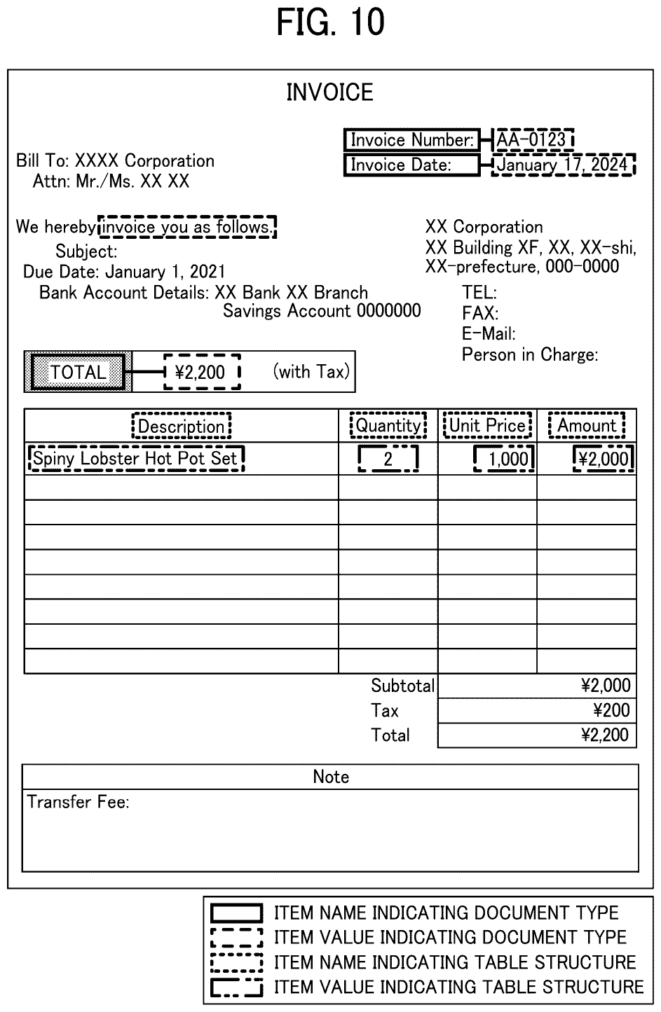

FIG. 9 is a flowchart of an example of a second designated document identification process performed by the document recognition apparatus 2 according to one embodiment. As illustrated in FIG. 9, further classification within designated documents (document identification process) includes four steps, i.e., steps S201 to S204. Details of each step will be described below with reference to FIG. 10. FIG. 10 is a diagram illustrating an example of document data handled in the document recognition apparatus 2 according to one embodiment. The document data includes the title, items, and the table structure for convenience of the description of each step.

First, extraction of the title in step S201 will be described.

The title extraction unit 19 extracts the title from the extracted text information. Known extraction methods include an extraction method based on conditional branching using comparison between a recognized character string and a dictionary, the character height, and the character position. The title is extracted using an existing method.

As the character strings indicating the respective document types, “invoice”, “delivery note”, “order form”, “quotation”, and “receipt” are known. Thus, the title extraction unit 19 searches the text information extracted from the document data for these character strings. The title extraction unit 19 determines whether the character height of the character string that has hit in the search is higher than the height of other character strings in the text information. This is because the title is usually written with large characters. The title extraction unit 19 determines whether coordinates of the character string that has hit in the search are in an upper half portion of the whole document. This is because the title is usually written in an upper part of the document.

When text information satisfying all of these three conditions is found, the title extraction unit 19 determines the text information as the title. The title extraction unit 19 may determine the text information as the title when the text information meets one or two of the three conditions.

Extraction of an item name and an item value in step S202 will be described below.

The item name/item value extraction unit 17 extracts character strings corresponding to the item name and the item value that indicate the document type from the extracted text information. The extraction methods include an extraction method based on regular expressions prepared in advance, and a method of using the classifier 23 of item names and item values obtained by machine learning.

For example, in the case of the invoice, the item names indicating the document type are “Total”, “Invoice Date”, and “Invoice Number”. The item values indicating the document type include “\2,200”, “Jan. 17, 2024”, “AA-0123”, and “invoice you as follows”.

The item name/item value extraction unit 17 extracts character strings corresponding to item names and item values that indicate the table structure from the recognized text information. The extraction methods include an extraction method based on regular expressions prepared in advance, and a method of using the classifier 23 of item names and item values obtained by machine learning.

For example, in the case of the invoice, the item names indicating the table structure include “Description”, “Quantity”, “Unit Price”, and “Amount”. The item values indicating the table structure include “Spiny Lobster Hot Pot Set”, “2”, “\1,000”, and “\2,000”.

As an example of the item names and the item values extracted from an example of the invoice, FIG. 10 illustrates the item names and the item values indicating the document type with rectangular frames. FIG. 10 also illustrates the item names and the item values indicating the table structure with rectangular frames. Extraction of the table structure in step S203 will be described next.

The table structure extraction unit 18 performs ruled line extraction to acquire ruled line information from the document data. The table structure includes the ruled line information, the item names and item values indicating the table structure, and a combination thereof. The combination includes a concept of a positional relationship. The positional relationship may be represented by coordinates in the document data.

Determination in step S204 will be described lastly.

As described below, the user may prepare in advance the classifier 23 for identifying documents to be classified (e.g., in the case of the invoice group, the invoice, the quotation, the receipt, the delivery note, and the order form). The classifier 23 may be any identification machine for classifying the document types. Examples of the classifier 23 include a gradient-boosted decision tree and a support vector machine. The designated document identification unit 22 inputs structure information of the document data to the classifier 23, and acquires an identification result of the type of the document data from the classifier 23.

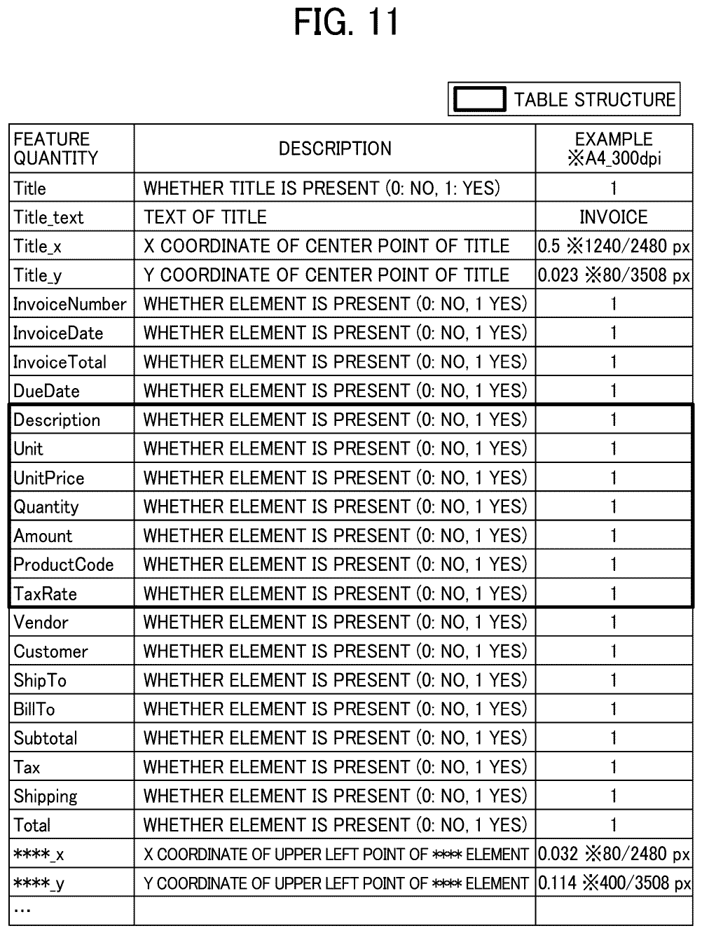

The structure information will be described with reference to FIG. 11. FIG. 11 is a diagram illustrating an example of the structure information handled in the document recognition apparatus 2 according to one embodiment. The structure information is, for example, information including the extraction result of the title, the extraction result of the item names and item values indicating the document type, and the table information as feature quantities. FIG. 11 illustrates an example of the feature quantities input as the structure information. FIG. 11 illustrates the description and the example data in association with each feature quantity.

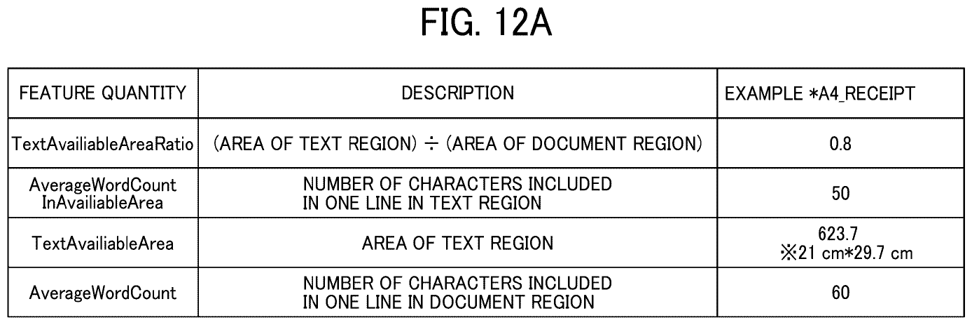

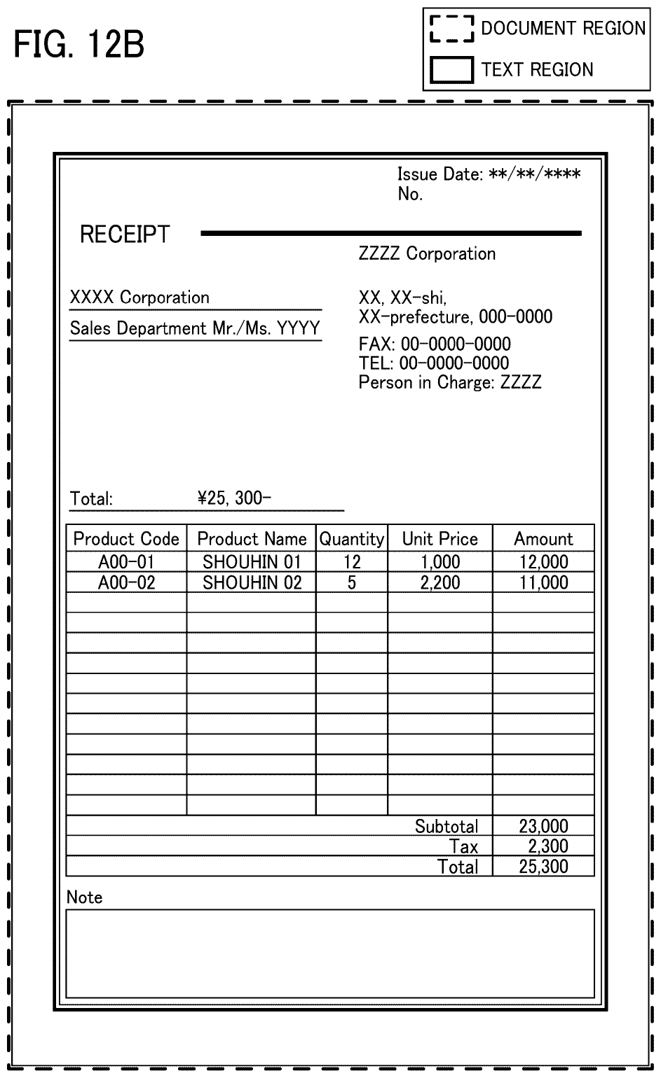

The structure information in the case where the document type is the receipt will be described with reference to FIGS. 12A and 12B. FIGS. 12A and 12B are diagrams illustrating an example of the structure information handled in the document recognition apparatus 2 according to one embodiment.

The receipt is taken as an example. The feature quantities in the case of the receipt are represented by a ratio between an area of a document region and an area of a text region, the number of characters included in one line in the text region, an area of the text region, the number of characters included in one line in the document region, and so on. FIG. 12A illustrates an example of the feature quantities input as the structure information. FIG. 12A illustrates the description and the example data in association with each feature quantity. FIG. 12B illustrates an example of the document region and the text region.

### Generation of Classifier 23

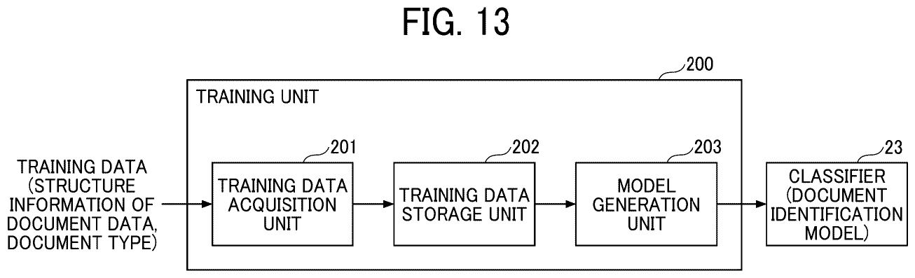

Generation of the classifier 23 will be described with reference to FIG. 13. FIG. 13 is a block diagram of an example of functions of a training unit 200 that generates the classifier 23 in the document recognition apparatus 2 according to one embodiment.

The training unit 200 is implemented as a result of any information processing apparatus executing a program. The training unit 200 has a function of generating a document type determining model. The training unit 200 includes a training data acquisition unit 201, a training data storage unit 202, and a model generation unit 203. The training data acquisition unit 201 acquires training data. For example, the training data includes input data, which is the structure information of document data, and labeled data, which is the document type.

The training data acquisition unit 201 acquires the training data and stores the training data in the training data storage unit 202. A plurality of sets, each formed of the input data and the labeled data, are prepared as the training data.

The training data storage unit 202 stores the training data acquired by the training data acquisition unit 201. The model generation unit 203 learns the training data according to any of various algorithms of machine learning to generate the classifier 23 (document identification model). The classifier 23 can be expressed as correspondence information that associates the structure information with the document type. The document identification model according to the present embodiment is a classification model for classifying the structure information. Examples of the classification model used in supervised learning include gradient boosting, a neural network, a support vector machine, logistic regression, a decision tree, and a random forest. Examples of the classification model used in unsupervised learning include a k-means method, a Gaussian mixture model, and an expectation-maximization (EM) algorithm.

Machine learning is performed as described above, so that the classifier 23 is generated. There are various methods for training and for creation of a program. In the present embodiment, training is performed using CatBoost.

In the training phase of the classifier 23, pieces of structure information each with a known document type are prepared. Thus, the training data is a vector in which a node corresponding to the intended document type has “1” and the other nodes have “0”. For example, the invoice, the quotation, and the other documents are to be identified. In the case of the structure information for which the document type is known as the invoice, the training data is a one-hot vector in which a vector element corresponding to the invoice alone is “1” and the other vector elements are “0”.

### Modification of Document Type Determination Process

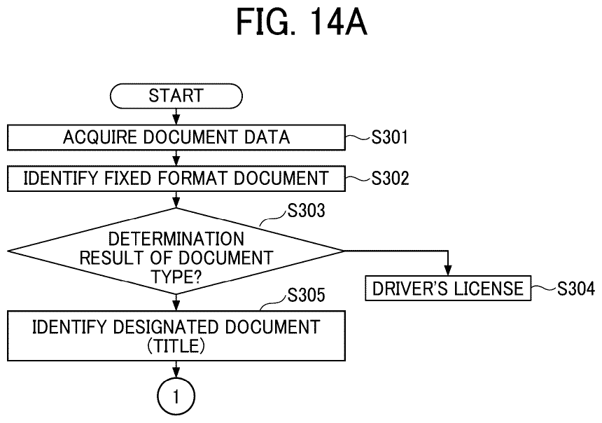

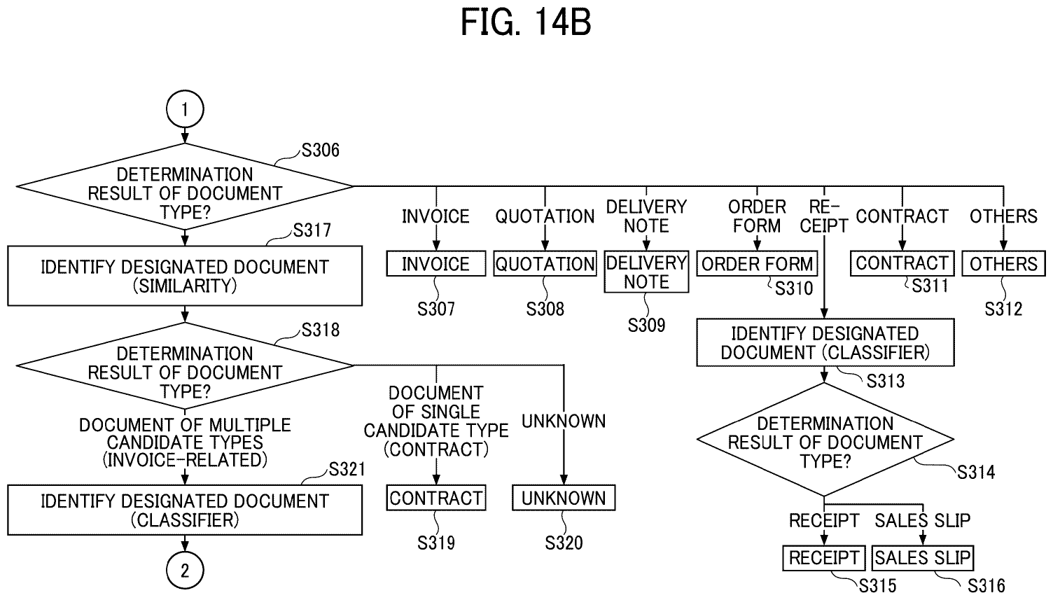

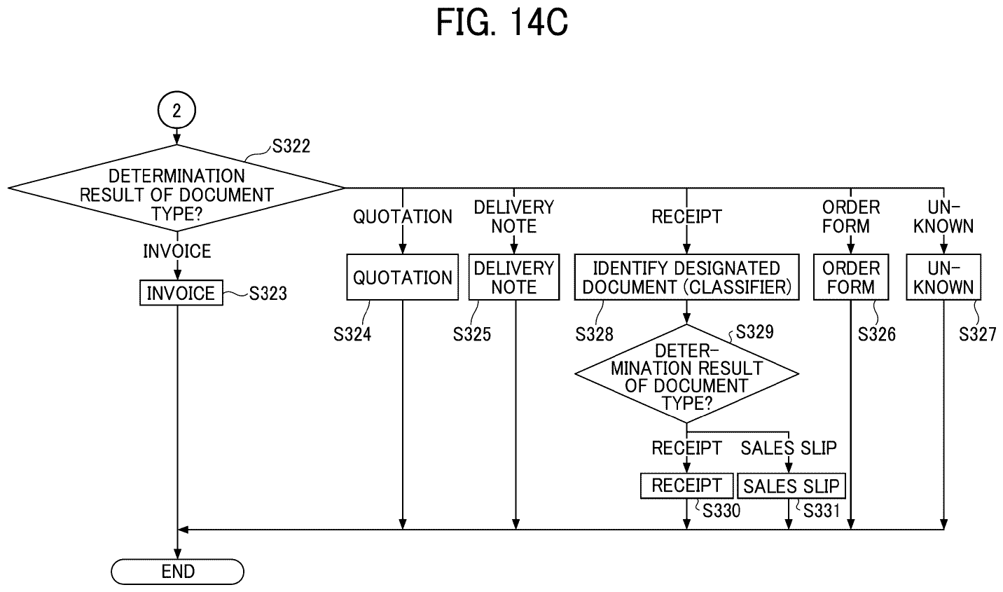

A modification of the document type determination process performed by the document recognition apparatus 2 will be described next. FIG. 14 is a flowchart of the modification of the document type determination process performed by the document recognition apparatus 2 according to one embodiment. As illustrated in FIG. 14, in this process, the document data is determined in steps as one of the fixed format document, the first designated document, the second designated document, and the other documents.

Note that in which step the determination is made for the document data depends on the document type. In FIG. 14, document types to be classified are as follows. Note that the receipt may include the sales slip.

Fixed format document: driver's license First designated document: contract Second designated document: invoice, quotation, delivery note, receipt, and order form Other documents: warranty

The scanner device 4 reads a document to generate document data, or the user terminal 3 holds the generated document data. The acquisition unit 11 acquires such document data in step S301. The text extraction unit 12 performs character recognition such as OCR on the document data.

The fixed format document identification unit 21 identifies a fixed format document in step S302, and determines whether the text information (such as character strings and coordinates) and the table structure extracted from the document data correspond to the driver's license which is a fixed format document in step S303.

When the fixed format document identification unit 21 determines that the document data is the driver's license which is the fixed format document (YES in step S303), the process proceeds to step S304. In step S304, the document determination unit 16 determines that the document data is the driver's license which is the fixed format document. When the determination in step S303 indicates No, the process proceeds to step S305.

The title extraction unit 19 searches the text information for any of the character strings indicating the respective document types, i.e., “invoice”, “delivery note”, “order form”, “quotation”, and “receipt”, and determines the character string as the title based on the size and coordinates of these characters in step S305.

In step S306, the designated document identification unit 22 determines the document type, based on a determination result based on the title obtained in step S305.

When the document type of the document data is identified as the invoice, the document determination unit 16 determines that the document type is the invoice in step S307. When the document type of the document data is identified as the quotation, the document determination unit 16 determines that the document type is the quotation in step S308. When the document type of the document data is identified as the delivery note, the document determination unit 16 determines that the document type is the delivery note in step S309.

When the document type of the document data is identified as the order form, the document determination unit 16 determines that the document type is the order form in step S310. When the document type of the document data is identified as the contract, the document determination unit 16 determines that the document type is the contract in step S311. When the document type of the document data is identified as the others, the document determination unit 16 determines that the document type is the warranty which is the other document in step S312.

The document data for which the document type is determined as the receipt may include the document type of the sales slip. Thus, the designated document identification unit 22 and the identification unit 15 identify whether the document data included in the receipt includes the sales slip in step S313. In step S314, the designated document identification unit 22 determines the document type, based on an identification result obtained in step S313.

When the document type of the document data is identified as the receipt, the document determination unit 16 determines that the document type is the receipt in step S315. When the document type of the document data is identified as the sales slip, the document determination unit 16 determines that the document type is the sales slip in step S316.

The similarity determination unit 20 calculates a similarity between a template prepared in advance for the first designated document and information obtained by converting the document data to have the same format as the template in step S317, and determines whether the similarity is higher than or equal to a threshold in step S318. When a plurality of templates are prepared, the information is compared with all the templates.

The document determination unit 16 determines the document data for which just the contract is determined, as the contract which is the first designated document, in step S319. When the document data is of an unknown type, the document determination unit 16 processes the document data such that the document type is unknown in step S320.

The document determination unit 16 determines, as the second designated document, a piece of document data for which a plurality of document types are determined, among the pieces of document data that are not determined as the fixed format document. The designated document identification unit 22 and the identification unit 15 identify the document type the document data corresponds to among the document types in step S321. In step S322, the designated document identification unit 22 determines the document type, based on an identification result obtained in step S321.

When the document type of the document data is identified as the invoice, the document determination unit 16 determines that the document type is the invoice in step S323. When the document type of the document data is identified as the quotation, the document determination unit 16 determines that the document type is the quotation in step S324. When the document type of the document data is identified as the delivery note, the document determination unit 16 determines that the document type is the delivery note in step S325.

When the document type of the document data is identified as the order form, the document determination unit 16 determines that the document type is the order form in step S326. When the document data is of an unknown type, the document determination unit 16 processes the document data such that the document type is unknown in step S327. When the document type of the document data is identified as the receipt, the document determination unit 16 determines that the document type is the receipt in step S328.

As in the processing in step S313, the designated document identification unit 22 and the identification unit 15 identify whether the document data included in the receipt includes the sales slip in step S328. In step S329, the designated document identification unit 22 determines the document type, based on an identification result obtained in step S328.

When the document type of the document data is identified as the receipt, the document determination unit 16 determines that the document type is the receipt in step S330. When the document type of the document data is identified as the sales slip, the document determination unit 16 determines that the document type is the sales slip in step S331.

When determining the document type, the document recognition apparatus 2 according to the present embodiment determines the document type based on step-by-step determination of the document type and a combination of the character string and the structure of the document data. The step-by-step determination of the document type allows various documents to be classified accurately. The determination based on the combination of the structure of the document data and the character string allows various documents to be classified accurately. For example, the use of the text information and the structure information in the determination allows documents having similar contents to be classified.

Thus, the document recognition apparatus 2 according to one embodiment successfully improves the accuracy of determining various documents.

While the embodiments have been described above, the present disclosure is not limited to the embodiments described above and may be variously modified and improved within the scope of the present disclosure.

### Aspects of the Present Disclosure are as Follows, for Example.

According to Aspect 1, a document recognition apparatus includes a text extraction unit, an identification unit, and a document determination unit. The text extraction unit extracts text information from document data. The identification unit identifies an item character string and a structure of the document data from the extracted text information. The item character string is a character string for identifying a document type of the document data. The document determination unit determines the document type of the document data, based on a combination of the item character string and the structure of the document data.

According to Aspect 2, in the document recognition apparatus of Aspect 1, the document determination unit determines the document type of the document data in a plurality of steps using a trained model. The trained model is a model that has learned a feature quantity for each of document types using the document types as training data. The feature quantity is calculated based on the structure of the document data and the item character string.

According to Aspect 3, in the document recognition apparatus of Aspect 2, the document data is one of a plurality of pieces of document data. The document determination unit determines, as a fixed format document, a piece of document data corresponding to a predetermined format among the plurality of pieces of document data; determines, as a first designated document, a piece of document data for which just a single document type is determined based on the combination of the structure of the document data and the item character string, among pieces of document data that are not determined as the fixed format document among the plurality of pieces of document data; determines, as a second designated document, a piece of document data for which a plurality of document types are determined among the pieces of document data that are not determined as the fixed format document; and determines the document type of the piece of document data corresponding to the second designated document, based on a similarity to each of the document types which the trained model has learned.

According to Aspect 4, a document recognition method to be performed by one or more computers, includes: extracting text information from document data; identifying an item character string and a structure of the document data from the extracted text information, the item character string being a character string for identifying a document type of the document data; and determining the document type of the document data, based on a combination of the item character string and the structure of the document data.

According to Aspect 5, a program causes one or more computers to perform a process including: extracting text information from document data; identifying an item character string and a structure of the document data from the extracted text information, the item character string being a character string for identifying a document type of the document data; and determining the document type of the document data, based on a combination of the item character string and the structure of the document data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A document recognition apparatus comprising:
circuitry configured to:
extract text information from document data;
identify an item character string and a structure of the document data from the extracted text information, the item character string being a character string for identifying a document type of the document data; and
determine the document type of the document data, based on a combination of the item character string and the structure of the document data.

2. The document recognition apparatus according to claim 1, wherein the circuitry is configured to determine the document type of the document data in a plurality of steps using a trained model, the trained model being a model that has learned a feature quantity for each of document types using the document types as training data, the feature quantity being calculated based on the structure of the document data and the item character string.

3. The document recognition apparatus according to claim 2, wherein
the document data is one of a plurality of pieces of document data, and
the circuitry is configured to:
determine, as a fixed format document, a piece of document data corresponding to a predetermined format among the plurality of pieces of document data;
determine, as a first designated document, a piece of document data for which a single document type is determined based on the combination of the structure of the document data and the item character string, among pieces of document data that are not determined as the fixed format document among the plurality of pieces of document data;
determine, as a second designated document, a piece of document data for which a plurality of document types are determined among the pieces of document data that are not determined as the fixed format document; and
determine the document type of the piece of document data corresponding to the second designated document, based on a similarity to each of the document types which the trained model has learned.

4. A document recognition method to be performed by one or more computers, comprising:
extracting text information from document data;
identifying an item character string and a structure of the document data from the extracted text information, the item character string being a character string for identifying a document type of the document data; and
determining the document type of the document data, based on a combination of the item character string and the structure of the document data.

5. A computer-readable, non-transitory medium storing a computer program, the computer program causing one or more computers to perform a process comprising:
extracting text information from document data;
identifying an item character string and a structure of the document data from the extracted text information, the item character string being a character string for identifying a document type of the document data; and
determining the document type of the document data, based on a combination of the item character string and the structure of the document data.
